(19) United States
(12) Patent Application Publication
(10) Pub. No.: US 2025/0091412 A1
(43) Pub. Date: Mar. 20, 2025

(54) SLIDING FLAP OF A HEATING, VENTILATION AND/OR AIR-CONDITIONING DEVICE FOR A PASSENGER COMPARTMENT OF A VEHICLE

(71) Applicant: VALEO SYSTEMES THERMIQUES, Le Mesnil-Saint-Denis (FR)

(72) Inventors: Stefan Gaertner, Bad Rodach (DE); Philippe Pierres, Le Mesnil-Saint-Denis (FR); Nestor Ismael Varela Santoyo, Toluca (MX)

(73) Assignee: VALEO SYSTEMES THERMIQUES, Le Mesnil-Saint-Denis (FR)

(21) Appl. No.: 18/724,194

(22) PCT Filed: Dec. 12, 2022
(86) PCT No.: PCT/EP2022/085280

§ 371 Date: Jun. 26, 2024

(30) Foreign Application Priority Data
Dec. 31, 2021 (FR) FR2114712

(51) Int. Cl. B60H 1/34

(52) U.S. Cl. CPC B60H 1/3414

(57) ABSTRACT

A heating, ventilation and/or air conditioning device is disclosed. The device includes at least one air inlet, at least one air outlet which is able to direct the flow of air to a front area of the passenger compartment, and a second air outlet which is able to direct the flow of air to a rear area of the passenger compartment. The device also includes one first heat exchanger and one second heat exchanger positioned downstream from the first heat exchanger relative to a direction of circulation of the flow of air within the device. The device also includes one first chamber for mixing the flow of air which is connected fluidically to the first air outlet and at least one second chamber for mixing the flow of air which is connected fluidically to the second air outlet.

The present invention concerns heating, ventilation and/or air-conditioning devices for vehicles. More particularly, the invention concerns heating, ventilation and/or air conditioning devices to regulate the temperature of a flow of air directed to different areas of a passenger compartment of the vehicle.

Heating, ventilation and/or air conditioning devices habitually comprise at least two heat exchangers, including at least one first heat exchanger designed to cool a flow of air, and one second heat exchanger designed to heat the flow of air. The heat exchangers assure regulation of the temperature of the flow of air passing through said device, said flow of air being designed to exit via different air outlets directed towards different areas of the passenger compartment of the vehicle. The different areas of the passenger compartment are for example a front area, comprising in particular the driver, and a rear area comprising in particular rear passengers. In order to obtain a flow of air with a temperature determined by a user of the vehicle, the device comprises at least two mixing chambers which assure the mixing of the flow of air which has passed through the first heat exchanger, optionally with part of the flow of air having passed through the second heat exchanger. Thus, a first mixing chamber is connected fluidically to at least one air outlet directed towards the front area of the passenger compartment, whereas a second mixing chamber is connected fluidically to at least one air outlet directed towards the rear area of the passenger compartment.

In order to regulate the quantities of flow of air reaching each of the mixing chambers from each of the heat exchangers, it is known to use regulation means which can take the form for example of rotary flaps. Although these regulation means are efficient, in particular for the first mixing chamber, they can be improved in particular for the second mixing chamber such as to leave more space, and begin the mixing of the flows of air sooner in the mixing chamber.

The objective of the present invention is thus to improve the means for regulation of the flow of air reaching the second mixing chamber connected fluidically to at least one air outlet directed towards the rear area of the passenger compartment, in particular making it possible to increase the volume of said second mixing chamber. Increasing the volume of the second mixing chamber thus improves the mixing of the flows of air within it. The invention thus relates to a heating, ventilation and/or air conditioning device for a passenger compartment of a vehicle, said device comprising at least one air inlet, at least one first air outlet which can direct the flow of air to a front area of the passenger compartment, and a second air outlet which can direct the flow of air to a rear area of the passenger compartment, the device comprising at least one first heat exchanger and one second heat exchanger positioned downstream from the first heat exchanger relative to a direction of circulation of the flow of air within the device, the device comprising at least one first chamber for mixing of the flow of air which is connected fluidically to the first air outlet, and at least one second chamber for mixing of the flow of air which is connected fluidically to the second air outlet, the device comprising at least one first air path passing through the second heat exchanger, and one second air path which bypasses the second heat exchanger, the first air path and the second air path opening onto the second mixing chamber, the device being characterized in that it comprises at least one sliding flap positioned between at least one of the air paths and the second mixing chamber.

The heating, ventilation and/or air conditioning device according to the invention assures the regulation of the temperature of a flow of air within a passenger compartment, and in particular a front area comprising at least the driver, and a rear area comprising at least rear passengers. The first heat exchanger thus permits cooling of the flow of air entering the device, therefore forming a flow of cold air, whereas the second heat exchanger makes it possible to heat this flow of air, forming a flow of hot air. The first mixing chamber communicates fluidically with the first air outlet which is designed to direct a first mixed flow of air towards the front area of the passenger compartment, and the second mixing chamber communicates fluidically with the second air outlet which is designed to direct a second mixed flow of air towards the rear area of the passenger compartment.

In addition, the first air path permits the circulation of the flow of hot air, and the second air path permits the circulation of the flow of cold air exiting from the first heat exchanger, said air paths guiding these flows of air towards the second mixing chamber. It is understood that thus, the sliding flap makes it possible to control a proportion of flow of cold air, otherwise known as the first flow of air, and of the flow of hot air, known as the second flow of air, entering the second mixing chamber.

According to a characteristic of the invention, the sliding flap is mobile between at least one first position, in which it isolates the first air path fluidically against the second mixing chamber, and one second position, in which it isolates the second air path fluidically against the second mixing chamber.

In other words, the sliding flap makes it possible to interrupt a circulation of the flow of air from the first air path towards the second mixing chamber when it is in its first position, or a circulation of the flow of air from the second air path towards the second mixing chamber when it is in its second position. It is understood that the sliding flap can isolate all of the first air path fluidically, or all of the second air path, against the second mixing chamber. When all of one of the air paths is isolated fluidically against the second mixing chamber, all of the other air path is open onto said second mixing chamber.

According to a characteristic of the invention, the sliding flap adopts an intermediate position between its first position and its second position, in which it isolates the first air path partly, fluidically against the second mixing chamber, and isolates the second air path partly against the second mixing chamber.

The sliding flap can thus adopt two extreme positions and any intermediate positions between these two extreme positions.

According to a characteristic of the invention, the second mixing chamber is positioned fluidically between the sliding flap and a shutter flap which is mobile between an open position, in which it permits the passage of the flow of air from the second mixing chamber to the second air outlet, and a closed position, in which it prevents the circulation of air from the second mixing chamber to the second air outlet. The shutter flap is a flap for closure of the second mixing chamber, which makes it possible to isolate the rear area of the passenger compartment, for example in the absence of an occupant in this area.

According to an alternative of the invention, the shutter flap is mobile only between its open position and its closed position. It is thus understood that the sliding flap assures the regulation of the flow rate of the first flow of air and of the second flow of air reaching the second mixing chamber, whereas the shutter flap makes it possible to permit or prevent the passage of the second mixed flow of air from the second mixing chamber to the rear area of the passenger compartment.

According to a characteristic of the invention, the device for heating, ventilation and/or air conditioning comprises a mixing flap which is positioned fluidically between the first heat exchanger and the first mixing chamber for the flow of air, which chamber is connected fluidically to the first air outlet. It is understood here that the installation is provided with two distinct mixing chambers, each allocated to a different area of the passenger compartment.

According to a characteristic of the invention, the sliding flap is mobile in translation in a direction of translation which is substantially perpendicular, or perpendicular, to the flow of air which passes along at least one of the paths.

According to the invention, the sliding flap is displaced outside a volume of the second mixing chamber. During a translation of the sliding flap, this therefore makes it possible to maintain a volume of the second mixing chamber which is optimal for mixing of the first flow of air and the second flow of air arriving respectively via the second air path and the first air path.

According to a characteristic of the invention, the device for heating, ventilation and/or air conditioning comprises at least one first mouth between the first air path and the second mixing chamber, and one second mouth between the second air path and the second mixing chamber, the first mouth and the second mouth each having a perimeter with a form and dimensions complementary to a perimeter of the sliding flap.

It is understood that a characteristic of this type makes it possible for the sliding flap to close entirely one out of the first mouth or the second mouth, in order to isolate one or the other of the first air path or the second air path fluidically against the second mixing chamber.

According to a characteristic of the invention, the sliding flap comprises at least two stop edges each positioned at one of the transverse ends of the sliding flap in its direction of translation, each of the stop edges being able to cooperate with a stop wall which delimits the mouths of the heating, ventilation and/or air conditioning device.

It is understood from a characteristic of this type that the sliding flap extends in a space of a housing which delimits the heating, ventilation and/or air conditioning device.

According to a characteristic of the invention, the heating, ventilation and/or air conditioning device comprises at least one sliding unit of the sliding flap. The sliding unit makes it possible in particular to guide the displacement in translation of the sliding flap between its first position and its second position. The sliding unit can thus be a deformation, in particular a groove, in the housing in which the sliding flap is translated, or also a frame which is added onto the housing, and comprises at least one guide rail.

According to a characteristic of the invention, the sliding flap comprises at least one actuation means which can cooperate with at least one means for controlling a translation of the sliding flap.

The cooperation between the actuation means and the control means permits the displacement in translation of the sliding flap between its first position and its second position. According to a non-limiting example of the invention, the means for actuation of the sliding flap can be linear toothing, and the control means can be a gear, the rotation of which around an axis of rotation drives the sliding flap in translation.

According to a characteristic of the invention, the means for controlling the sliding flap is a rotary element which can rotate in two directions of rotation around an axis of rotation of the rotary element.

The rotation of the control means in a first direction drives the sliding flap in translation towards the first mouth, whereas the rotation of the control means in a second direction, opposite the first direction, drives the sliding flap in translation towards the second mouth.

According to a characteristic of the invention, the control means is positioned in the second mixing chamber.

According to a characteristic of the invention, the device for heating, ventilation and/or air conditioning comprises a housing which accommodates the two heat exchangers, the housing comprising at least one wall which delimits the two air paths, and an end edge of which delimits the two mouths at least partly, the end edge of said wall being opposite the sliding flap irrespective of the position of said sliding flap.

The invention also relates to a motor vehicle comprising at least one device for heating, ventilation and/or air conditioning according to any one of the preceding characteristics, which device is designed to heat or cool a front area and/or a rear area of the passenger compartment of said vehicle.

Other characteristics, details and advantages of the invention will become more clearly apparent from reading the description provided hereinafter by way of indication in relation with drawings in which:

Fig. 1 is a general view of a motor vehicle comprising a device for heating, ventilation and/or air conditioning according to the invention;

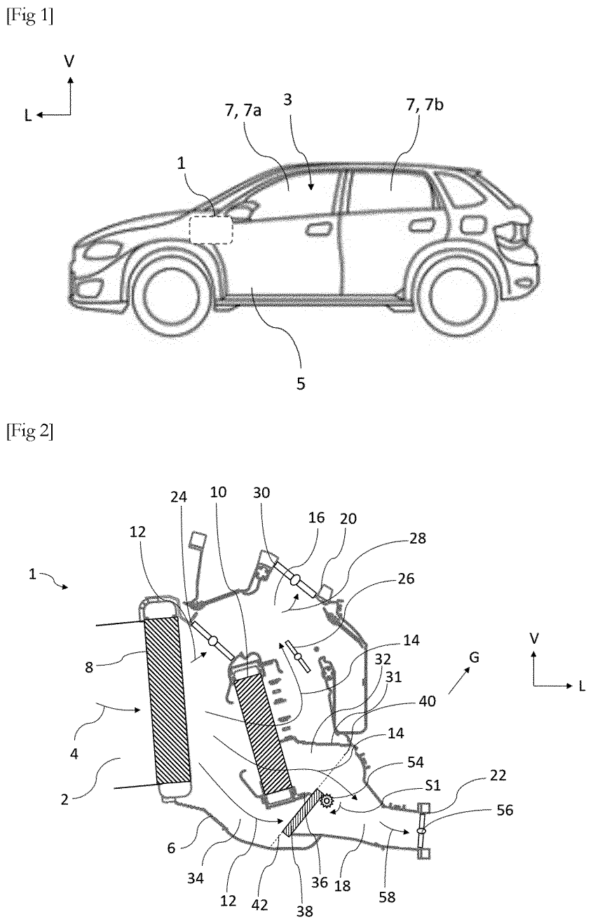

Fig. 2 is a schematic view in cross-section along a vertical and longitudinal plane of the device for heating, ventilation and/or air-conditioning of FIG. 1 showing a sliding flap in a second position;

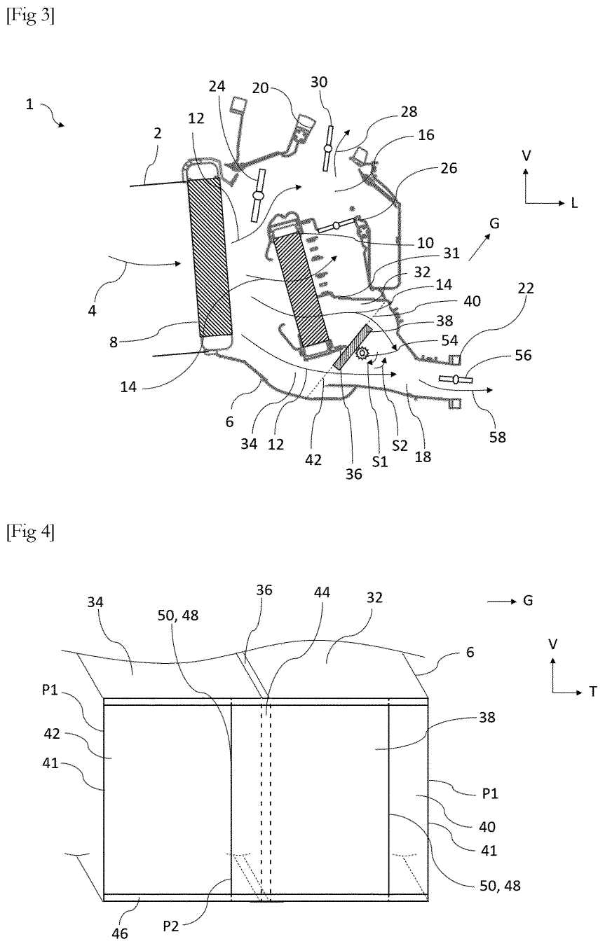

Fig. 3 is a schematic view in cross-section along a vertical and longitudinal plane of the device for heating, ventilation and/or air conditioning of FIG. 1 showing a sliding flap in an intermediate position;

Fig. 4 is a schematic view in perspective of the sliding flap in the device for heating, ventilation and/or air conditioning of FIG. 1;

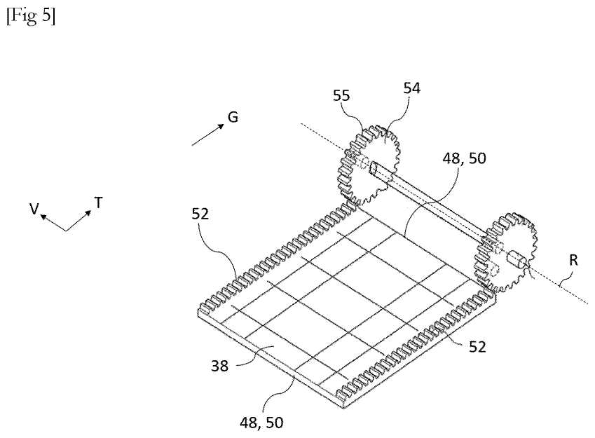

Fig. 5 is a view in perspective of the sliding flap of the device for heating, ventilation and/or air conditioning of FIG. 1 and of a means for controlling said sliding flap.

It should first of all be noted that, while the figures set out the invention in detail for the implementation thereof, it will be appreciated that these figures may be used to define the invention better, where appropriate. It should also be noted that these figures show only a few embodiments of the invention.

FIG. 1 illustrates a device for heating, ventilation and/or air conditioning 1, hereinafter known as the device 1, for a passenger compartment 3 of a vehicle 5, in this case a motor vehicle, which device is designed to regulate the temperature of flows of air directed to a plurality of areas 7 of the passenger space 3, and in particular a front area 7a where at least one driver can be installed, and a rear area 7b which is designed to receive at least one rear passenger.

The device 1, shown in FIGS. 2 and 3, comprises at least one air inlet 2 in which there is engulfed a flow of air 4 entering the interior of a housing 6 of the device 1.

The housing 6 of the device 1 is an envelope which delimits an interior volume which accommodates at least one first heat exchanger 8 positioned on the path of the flow of air 4 entering, and such that said flow of air 4 entering passes through it. The housing 6 also accommodates a second heat exchanger 10 positioned downstream from the first heat exchanger 8 in relation to a direction of circulation of the flow of air in the housing 6 of the device 1, and such that part of the flow of air can pass through it, and another part of the flow of air bypasses it.

According to an example of the invention, the first heat exchanger 8 makes it possible to cool the flow of air 4 entering, such as to form a first, cold flow of air 12, whereas the second heat exchanger 10 makes it possible to heat the first flow of air 12 exiting from the first heat exchanger 8 in order to generate a second, hot flow of air 14.

The device 1 also comprises at least one first mixing chamber 16 and one second mixing chamber 18, which are designed to receive and/or mix the first flow of air 12 exiting from the first heat exchanger 8 and the second flow of air 14 exiting from the second heat exchanger 10, with the first mixing chamber 16 being connected to at least one first air outlet 20 which is directed towards the front area of the passenger compartment, whereas the second mixing chamber 18 is connected to at least one second air outlet 22 which is directed towards the rear area of the passenger compartment. It is thus understood that the mixing chambers 16, 18 can each receive the first, cold flow of air 12 exiting from the first heat exchanger 8, and the second, hot flow of air 14 exiting from the second heat exchanger 10, in order to obtain at least two flows of air mixed at the outlet of the device 1 with a determined temperature, i.e. which is required by the driver and/or the rear passenger of the vehicle.

In order to adjust the temperature of the flow of air directed towards the front area of the passenger compartment, the requirements for the first flow of air 12 and for the second flow of air 14 in the first mixing chamber 16 are adjusted, at least by means of a first mixing flap 24 and a second mixing flap 26. More specifically, the first mixing flap 24 is positioned between the first heat exchanger 8 and the first mixing chamber 16, on the path of the first flow of air 12 towards the mixing chamber 16. The first mixing flap 24 is thus in the form of a rotary flap which can be displaced from a position which is at least partly open, shown in FIG. 3, in which it permits the passage of the first flow of air 12 towards the first mixing chamber 16, to a closed position, shown in FIG. 2, in which it blocks the passage of the first flow of air 12 towards the first mixing chamber 16.

It is understood that, in a closed position of the first mixing flap 24, the first flow of air 12 coming from the first heat exchanger 8 is forced to pass through all of the second heat exchanger 10, in order to reach the first mixing chamber 16. It is also understood that, in an open position of the first mixing flap 24, part of the first flow of air 12 arrives directly in the first mixing chamber 16, and another part of the first flow of air 12 passes through the second heat exchanger 10, in order to form the second flow of air 14. Thus, a closed position of the first mixing flap 24 is required when the requirements for the first, cold flow of air 12 in the first mixing chamber 16 are zero.

The second mixing flap 26 is positioned at the outlet of the second heat exchanger 10, between the exchanger and the first mixing chamber 16. The second mixing flap 26 is thus mobile between an open position, shown in FIG. 2, in which it permits the passage of the second flow of air 14 into the first mixing chamber 16, and a closed position, shown in FIG. 3, in which it blocks the passage of the second flow of air 14 towards the first mixing chamber 16. Thus, it is understood that the second mixing flap 26 is placed in its open position when the requirements for the second, hot flow of air 14 within the first mixing chamber 16 exist, and it is in its closed position when the requirements for the second, hot flow of air 14 within the first mixing chamber 16 are zero.

It is understood that the first mixing flap 24 and the second mixing flap 26 make it possible to regulate the requirements respectively for the first, cold flow of air 12 and for the second, hot flow of air 14 within the first mixing chamber 16, such as to obtain a first flow of air 28 mixed within said first mixing chamber 16 which has a temperature determined by the driver and/or the front passenger of the vehicle. The first flow of air 28 mixed in the first mixing chamber 16 is then directed towards the first air outlet 20, with this outlet being controlled by a front closure flap 30.

This front closure flap 30 of the first air outlet 20 is mobile between an open position, in which it permits the passage of the first mixed flow of air 28 from the first mixing chamber 16 to the front area of the passenger compartment, and a closed position, in which it blocks the passage of the first mixed flow of air 28 from the first mixing chamber 16 to the front area of the passenger space, the passage from one to the other of the positions of the front closure flap 30 being implemented according to requirements determined by the front passengers of the vehicle.

As shown in FIGS. 2 and 3, the device 1 comprises at least one first air path 32 which passes through the second heat exchanger 10, and one second air path 34 which bypasses the second heat exchanger 10, the first air path 32 and the second air path 34 opening onto the second mixing chamber 18. The housing 6 then comprises at least one wall 36 which delimits the two air paths 32, 34, such that the first air path 32 and the second air path 34 are isolated fluidly from one another. In addition, the housing 6 comprises a separation partition 31, which makes it possible to isolate the first mixing chamber 16 fluidically against the second mixing chamber 18 at the outlet of the second heat exchanger 10. More particularly, the separation partition 31 is formed at the outlet of the second heat exchanger 10, such as to separate the first path 32 which passes through the second heat exchanger 10 fluidically from an area of the first mixing chamber 16 which is positioned at the outlet of the second heat exchanger 10.

In order to adjust the temperature of the flow of air directed towards the rear area of the passenger compartment, the requirements for the first, cold flow of air 12 and the second, hot flow of air 14 within the second mixing chamber 18 are adjusted by means of at least one sliding flap 38 positioned at least between one of the air paths 32, 34 and the second mixing chamber 18.

The sliding flap 38 is mobile between at least a first position, in which it isolates the first air path 32 fluidically against the second mixing chamber 18, and a second position, shown in FIG. 2, in which it isolates the second air path 34 fluidically in relation to the second mixing chamber 18. More particularly, the sliding flap 38 is displaced from its first position to its second position by a movement of translation in a direction of translation G which is substantially perpendicular to a general direction of the first flow of air 12 and/or of the second flow of air 14 which passes through at least one of the air paths 32, 34.

With reference to FIG. 4, a first mouth 40 is defined between the first air path 32 and the second mixing chamber 18, and a second mouth 42 is defined between the second air path 34 and the second mixing chamber 18, with an end edge 44 of the wall 36 separating the two air paths 32, 34. This end edge 44 delimits the two mouths 40, 42 at least partly.

The housing 6 comprises at least one sliding unit 46 of the sliding flap 38 which is positioned on the periphery of the first mouth 40 and the second mouth 42. More particularly, the sliding unit 46 can be a deformation of the housing 6, in particular a groove, in which the sliding flap 38 is translated, and is formed on the periphery of the mouths 40, 42, or it can also be a frame added onto the housing 6 on the periphery of the mouths 40, 42, such as to form at least one guide rail of the sliding flap 38 in its direction of translation G. It is understood that a sliding unit 46 of this type makes it possible to guide the translation of the sliding flap 38 between its first position, its second position, and any intermediate positions situated between its first position and its second position, in its direction of translation G.

According to the invention, the first mouth 40 and the second mouth 42 each comprise a perimeter P1 with a form and dimensions which are complementary to a second perimeter P2 of the sliding flap 38. In other words, the sliding flap 38 is configured to obstruct entirely one or the other of the first mouth 40 or the second mouth 42. In particular, at least two stop edges 48 of the sliding flap 38 are defined, each positioned at one of the transverse ends 50 of the sliding flap 38 in its direction of translation G, each of the stop ends 48 being able to cooperate with a stop wall 41 which participates in delimiting each of the mouths 40, 42 of the device 1 in the direction of translation G of the sliding flap 38. More particularly, each of the stop edges 48 of the sliding flap 38 can cooperate with the stop wall 41 of each of the mouths positioned opposite the end edge 44 of the wall 36 along an axis parallel to the direction of translation G of the sliding flap 38.

The sliding flap 38 according to the invention can also adopt all intermediate positions, one of which is illustrated in FIG. 3, between its first position and its second position, and in which it isolates the first air path 32 partly, fluidically, against the second mixing chamber 18, and the second air path 34, partly, against the second mixing chamber 18. It is understood that, in a configuration of this type of the sliding flap 38, the flap reduces a flow rate of the first flow of air 12 circulating in the second air path 34 towards the second mixing chamber 18, and reduces a flow rate of the second flow of air 14 circulating in the first air path 32 towards the second mixing chamber 18. This therefore makes it possible to regulate the requirements for the first, cold flow of air 12 and the second, hot flow of air 14 in the second mixing chamber 18, such as to reach the temperature required by the occupants of the rear area of the passenger compartment.

It is also understood that the sliding flap 38 is not designed to exit from the sliding unit 46, i.e. from the housing 6. In other words, irrespective of the position of the sliding flap 38, it is always at least partly facing the end edge 44 of the wall 36 which separates the first air path 32 and the second air path 34.

In order to permit the mobility of the sliding flap 38 between the first position and the second position, the sliding flap 38, which can be seen in particular in FIG. 5, comprises at least one actuation means 52 which can cooperate with at least one means 54 for controlling the sliding flap 38. In the example illustrated of the invention, the actuation means 52 is linear toothing 52 formed on a longitudinal wall of the sliding flap 38 in its direction of translation G.

The control means 54 is a gear 54 which is mobile in rotation around an axis of rotation R, with teeth 55 of the gear 54 being able to cooperate with the toothing 52 of the sliding flap 38. According to the example of the invention shown in FIGS. 2 and 3, the control means 54 is positioned in the second mixing chamber 18, substantially between the first mouth 40 and the second mouth 42, in the alignment of the end edge 44 of the wall 36.

It is understood that the rotation of the gear 54 around its axis of rotation R drives the sliding flap 38 in translation in its direction of translation G. Thus, a first direction of rotation S1 and a second direction of rotation S2, shown in FIGS. 2 and 3 are defined, opposite one another around the axis of rotation of the control means 54, with the first direction of rotation S1 driving the sliding flap 38 in translation towards the first mouth 40, and the second direction of translation S2 driving the sliding flap 38 in rotation towards the second mouth 42.

As shown in FIGS. 2 and 3, the second mixing chamber 18 is positioned fluidically between the sliding flap 38 previously described, and a shutter flap 56, which is mobile substantially between an open position, shown in FIG. 3, in which it permits the passage of a second flow of mixed air 58 derived from the mixture of the first flow of air 12 and the second flow of air 14 in the second mixing chamber 18, towards the second air outlet 22, and a closed position, shown in FIG. 2, in which it prevents the circulation of the second flow of mixed air 58 from the second mixing chamber 18 towards the second outlet 22 for air directed towards the rear area of the passenger compartment. It is understood that the shutter flap 56 is tilted into its open position when the rear area of the passenger compartment requires heat treatment, and into its closed position when the rear area of the passenger compartment does not require heat treatment, for example because there is no rear passenger. The energy consumption of the heat exchanger is thus limited only when necessary.

Advantage is derived from the sliding flap according to the invention, and in particular its displacement in translation in the housing, in that it makes it possible to maintain an optimal volume of the second mixing chamber, and thus to improve the mixing between the first flow of air and the second flow of air within said second mixing chamber, by giving rise to this mixing from the beginning of the mixing chamber, i.e. as soon as the flow of air has gone beyond the first mouth and the second mouth.

The invention as described above is not, however, limited to the means and configurations exclusively described and illustrated, and also applies to all equivalent means or configurations and to any combination of such means or configurations.

1. A heating, ventilation and/or air conditioning device for a passenger compartment of a vehicle, the device comprising:
at least one air inlet;
at least one first air outlet which is able to direct the flow of air to a front area of the passenger compartment; and
a second air outlet which is able to direct the flow of air to a rear area of the passenger compartment;
at least one first heat exchanger and one second heat exchanger positioned downstream from the first heat exchanger relative to a direction of circulation of the flow of air within the device;
at least one first chamber for mixing of the flow of air which is connected fluidically to the first air outlet;
at least one second chamber for mixing of the flow of air which is connected fluidically to the second air outlet,
at least one first air path passing through the second heat exchanger;
one second air path which bypasses the second heat exchanger,
wherein the first air path and the second air path open onto the second mixing chamber; and
at least one sliding flap positioned between at least one of the air paths and the second mixing chamber.

2. The heating, ventilation and/or air conditioning device as claimed in claim 1,
wherein the sliding flap is mobile between at least one first position, in which it isolates the first air path fluidically against the second mixing chamber and one second position, in which it isolates the second air path fluidically against the second mixing chamber.

3. The heating, ventilation and/or air conditioning device as claimed in claim 2,
wherein the sliding flap adopts an intermediate position between its first position and its second position, in which it isolates the first air path partly, fluidically against the second mixing chamber, and isolates the second air path partly against the second mixing chamber.

4. The heating, ventilation and/or air conditioning device as claimed in claim 1,
wherein the second mixing chamber is positioned fluidically between the sliding flap and a shutter flap which is mobile between an open position, in which it permits the passage of the flow of air from the second mixing chamber to the second air outlet, and a closed position, in which it prevents the circulation of the flow of air from the second mixing chamber to the second air outlet.

5. The heating, ventilation and/or air conditioning device as claimed in claim 1,
further comprising a mixing flap which is positioned fluidically between the first heat exchanger and the first mixing chamber for the flow of air, which chamber is connected fluidically to the first air outlet.

6. The heating, ventilation and/or air conditioning device as claimed in claim 1,
wherein the sliding flap is mobile in translation in a direction of translation which is substantially perpendicular to the flow of air which passes through at least one of the air paths.

7. The heating, ventilation and/or air conditioning device as claimed in claim 6, further comprising:
at least one first mouth between the first air path and the second mixing chamber, and
one second mouth between the second air path and the second mixing chamber,
wherein the first mouth and the second mouth each comprise a perimeter with a form and dimensions complementary to a perimeter of the sliding flap.

8. The heating, ventilation and/or air conditioning device as claimed in claim 7,
wherein the sliding flap comprises at least two stop edges each positioned at one of the transverse ends of the sliding flap in its direction of translation,
wherein each of the stop edges is able to cooperate with a stop wall which delimits the mouths of the heating, ventilation and/or air conditioning device.

9. The heating, ventilation and/or air conditioning device as claimed in claim 1, further comprising at least one sliding unit of the sliding flap.

10. The heating, ventilation and/or air conditioning device as claimed in claim 1,
wherein the sliding flap comprises at least one actuation means which is able to cooperate with at least one means for controlling a translation of the sliding flap.

11. The heating, ventilation and/or air conditioning device as claimed in claim 10,
wherein the control means is positioned in the second mixing chamber.

12. The heating, ventilation and/or air conditioning device as claimed in claim 7,
further comprising a housing which accommodates the two heat exchangers, the housing comprising:
at least one wall which delimits the two air paths, and
an end edge of which delimits the two mouths at least partly,
wherein the end edge of the wall is opposite the sliding flap irrespective of the position of the sliding flap.

13. A vehicle comprising at least one device for heating, ventilation and/or air conditioning according to claim 1,
wherein the device is configured to heat or cool a front area and a rear area of a passenger compartment of the vehicle.
